(19) United States
(12) Patent Application Publication
(10) Pub. No.: US 2004/0186727 A1
(43) Pub. Date: Sep. 23, 2004

(54) Headset for playing pre-recorded information in response to a verbal command

(76) Inventor: Welesson Andrade, Piermont, NY (US)

Correspondence Address: Leonard & Proehl, Prof., LLC, Attn: Jeffrey A Proehl, 3500 South First Ave. Circle - Suite 250, Sioux Falls, SD, 57105-5802, US

(21) Appl. No.: 10/800,779

(22) Filed: Mar. 15, 2004

Related U.S. Application Data
(60) Provisional application No. 60/456,498, filed on Mar. 19, 2003.

(51) Int. Cl. G10L 11/00

(52) U.S. Cl. 704/275

(57) ABSTRACT

A headset for playing pre-recorded information in response to a verbal command includes an earpiece, an audio output assembly coupled to the earpiece, a microprocessor, a flexible member, and a microphone coupled to the flexible member. The microphone and audio output assembly are operationally coupled to the microprocessor so that a user hears an audio output such as a foreign language translation or recipe in response to a verbal input such as a native language term or recipe name.

### CROSS REFERENCE TO RELATED APPLICATION

This application claims the benefit of U.S. Provisional Application No. 60/456,498, filed Mar. 19, 2003.

### BACKGROUND OF THE INVENTION

1. Field of the Invention

The present invention relates to audio headsets and more particularly pertains to a new headset for playing pre-recorded information in response to a verbal command.

2. Description of the Prior Art

The use of audio headsets is known in the prior art. U.S. Pat. No. 5,914,914 issued to Moran on Jun. 22, 1999 describes a system for retrieving and presenting visual and audio information to a user. Another type of audio headset is U.S. Pat. No. 6,157,727 issued to Rueda on Dec. 5, 2000 having a hearing aid that translates input audio into a different language for output to the listener using the hearing aid. U.S. Pat. No. 6,122,617 issued to Tjaden on Sep. 19, 2000 discloses a system for supplying audio information to several end users.

While these devices fulfill their respective, particular objectives and requirements, the need remains for a self-contained portable headset device that stores information retrievable responsive to a voice command.

### SUMMARY OF THE INVENTION

The present invention generally comprises an earpiece, an audio output assembly coupled to the earpiece, a microprocessor, a flexible member, and a microphone coupled to the flexible member. The microphone and audio output assembly are operationally coupled to the microprocessor so that a user hears an audio output such as a foreign language translation or recipe in response to a verbal input such as a native language term or recipe name.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

The objects of the invention, along with the various features of novelty which characterize the invention, are pointed out with particularity in the claims annexed to and forming a part of this disclosure.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a new headset according to the present invention.

FIG. 2 is a perspective view of the present invention in use.

### DESCRIPTION OF THE PREFERRED EMBODIMENT

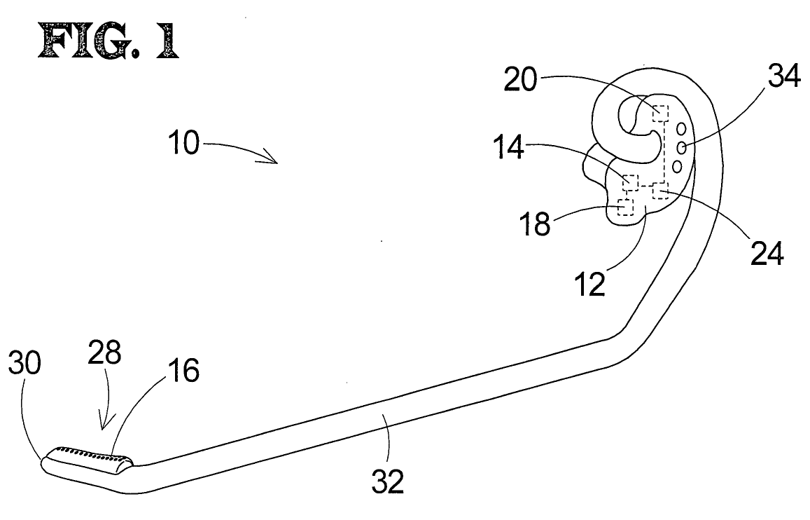

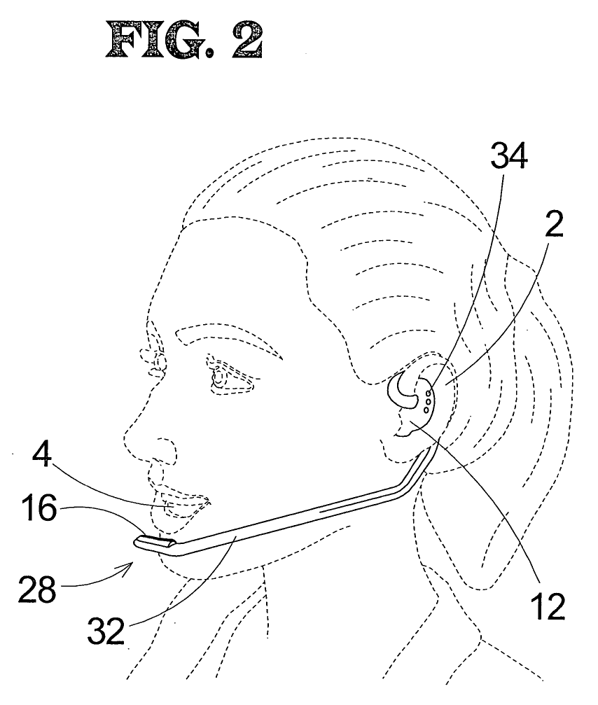

With reference now to the drawings, and in particular to FIGS. 1 and 2 thereof, a new headset for playing pre-recorded information in response to a verbal command embodying the principles and concepts of the present invention and generally designated by the reference numeral 10 will be described.

As best illustrated in FIGS. 1 and 2, the headset 10 for playing pre-recorded information in response to a verbal command generally comprises an earpiece 12 positionable adjacent to a user's ear 2. A command processing unit 14 is positioned in the earpiece 12. A microphone 16 is positionable adjacent a mouth 4 of the user when the earpiece 12 is positioned adjacent the user's ear 2. The microphone 16 is operationally coupled to the command processing unit 14 for providing the command processing unit 14 with a voice command from the user. A voice recognition assembly 18 is operationally coupled to the command processing unit 14 for identifying the voice command from the user. A memory chip 20 is operationally coupled to the command processing unit 14 or microprocessor for storing programmable responsive information. An audio output assembly 24 is operationally coupled to the command processing unit 14 and the earpiece 12 for providing the responsive information to the user in an audio format upon receiving the voice command from the user.

In an embodiment, the headset 10 is used to assist in the tasks of a bartender or short order cook by providing a list of ingredients as the information responsive to a recipe name as the voice command. Alternately, the input or voice command can be a word or phrase in a first language. The responsive information may be a translation of the word or phrase into a different language.

In an embodiment, the microphone 16 is positioned within a distal portion 28 or at a distal end 30 of a flexible member 32 for facilitating positioning of the microphone 16 adjacent to the user's mouth 4. In an embodiment, the earpiece 12 rests directly in the ear of the user and the flexible member 32 extends directly from the earpiece such that the headset is formed entirely by the earpiece and the flexible arm.

A connection port 34 is positioned in the earpiece 12 such that the command processing unit 14 and memory chip 20 are operationally couplable to a remote computer 6 to permit programming of the command processing unit 14 and memory chip 20 to provide customized input and responsive output in the form of a new language, new or additional recipes, and the like.

As stated above, the command processing unit responds to the key words or phrases used as voice commands by causing an audio response to be played through the earpiece so that the response is audible to the user.

In use, the user positions the earpiece in their ear and adjusts the flexible member to position the microphone in a convenient position that allows the microphone to pick up words spoken by the user. When the device is activated, the user speaks a word, the microprocessor identifies the word spoken and initiates a responsive audio output via the earpiece so that the audio output is audible to the user. The audio output may be the contents or steps of a recipe responsive to the user saying the name of the recipe or the audio output may be a foreign language translation of a word spoken in a language native to the user. Thus, the device could be used by a bartender, short order cook, traveler, or a student. Means for selectively programming the device can be included to permit selectable types of audio output such as a desired language or type or recipes. Additional uses include customized responses to user programmed inputs.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A headset for playing pre-recorded information in response to a verbal input comprising:
an earpiece positionable adjacent to a user's ear;
a command processing unit;
a microphone positionable adjacent a mouth of the user when the earpiece is positioned adjacent the user's ear, the microphone being operationally coupled to the command processing unit for providing the command processing unit with a voice command from the user;
a voice recognition assembly operationally coupled to the command processing unit for identifying the voice command from the user;
a memory chip operationally coupled to the microprocessor for storing programmable responsive information;
an audio output assembly operationally coupled to the command processing unit and the earpiece for providing the responsive information to the user in an audio format upon receiving the voice command from the user.

2. The headset of claim 1 wherein the voice command is a recipe name and the responsive information is a list of ingredients corresponding to the recipe of the voice command.

3. The headset of claim I wherein the voice command is a communication in a first language and the responsive information is a translation of the communication in a second language.

4. The headset of claim 1, further comprising:
the microphone being positioned at a distal end of a flexible member for facilitating positioning of the microphone adjacent to the user's mouth.

5. The headset of claim 1 further comprising:
a connection port in the earpiece such that the command processing unit and memory chip are operationally couplable to a remote computer to permit programming of the command processing unit and memory chip to provide customized input and responsive output.

6. The headset of claim 1 wherein the earpiece is structured to rest in the ear of the user.

7. The headset of claim 6 wherein the microphone is positioned on a distal portion of a flexible member extending from the earpiece.
